(19) United States
(12) Patent Application Publication
(10) Pub. No.: US 2016/0278183 A1
(43) Pub. Date: Sep. 22, 2016

(54) SIGHT AND OPERATING METHOD THEREOF

(71) Applicants: Chia-Chi Tang, Taichung (TW); Tzu-Ching Liao, Taichung (TW); Chi-Shiuan Hsieh, Taichung (TW)

(72) Inventors: Chia-Chi Tang, Taichung (TW); Tzu-Ching Liao, Taichung (TW); Chi-Shiuan Hsieh, Taichung (TW)

(73) Assignees: Sintai Optical (Shenzhen) Co., Ltd., Shenzhen City (CN); Asia Optical Co., Inc., Taichung (TW)

(21) Appl. No.: 14/663,475

(22) Filed: Mar. 20, 2015

(51) Int. Cl. H05B 37/02; G02B 23/00

(52) U.S. Cl. CPC H05B 37/0227; H05B 37/0218; G02B 23/00

(57) ABSTRACT

A sight and an operating method thereof are provided. The sight includes a light source, a motion sensor, and a control unit. The motion sensor is configured to detect a change of a motion direction of the sight and generate a detection signal based on the change of the motion direction. The control unit is configured to control brightness of the light source and determine whether the sight enters a sleep mode, wherein the control unit wakes up the sight from the sleep mode when the control unit receives the detection signal.

### BACKGROUND OF THE INVENTION

1. Field of the Invention

The invention relates to a sight and an operating method thereof.

2. Description of the Related Art

To save power and extend service the lifespan of batteries, conventional sights are provided with a sleep/power-saving mode. Under the sleep/power-saving mode, power sources of the conventional sights are automatically turned off if the conventional sights already work for a predetermined period. To use the sight again, a user pushes a power switch for turning on the power source, and the conventional sight returns to an operating mode which is executed before the power source is turned off.

Referring to FIG. 1, an operating method of a conventional sight is described as below.

In step S1020, it is determined whether a power switch is turned on. When the power switch is turned on, it indicates that a user is going to use the sight and the procedure goes to step S1030.

In step S1030, a memorized brightness mode is executed so that the conventional sight displays an aiming mark (e.g. a reticle or a red spot) in a high brightness mode, an intermediate brightness mode or an auto ambient detection mode. Supposed that the memorized brightness mode is the high brightness mode, the conventional sight automatically enters the high brightness mode after the power source is switched on. If the memorized brightness mode is the intermediate brightness mode, then the conventional sight automatically enters the intermediate brightness mode after the power source is switched on. If the memorized brightness mode is the auto ambient detection mode, then the conventional sight automatically enters the auto ambient detection mode after the power source is switched on. It is understood that the user can change the memorized brightness mode according to requirements.

In step S1040, it is determined whether the sight needs to enter a sleep mode for saving power. If the power source has been switched on for a period t equaling or exceeding a predetermined period td, then the step S1050 is executed to enter the sleep mode for saving power. Then, the procedure returns to the step S1020 to repeat the described operation.

From the above descriptions, it is understood that the user always needs to push the power switch to wake up the conventional sight before he can aim at an object with the conventional sight. As a result, the user may lose the object because it takes much time to have the conventional sight ready.

### BRIEF SUMMARY OF THE INVENTION

The invention provides a sight. The sight in accordance with an exemplary embodiment of the invention includes a light source, a motion sensor, and a control unit. The motion sensor is configured to detect a change of a motion direction of the sight and generate a detection signal based on the change of the motion direction. The control unit is configured to control brightness of the light source and determine whether the sight enters a sleep mode, wherein the control unit wakes up the sight from the sleep mode when the control unit receives the detection signal.

In another exemplary embodiment, the sight further includes a photo sensor configured to detect ambient brightness and provide ambient brightness information for the control unit, wherein the control unit controls the brightness of the light source according to the ambient brightness information.

In yet another exemplary embodiment, the sight further includes a power source configured to provide power for the control unit, the motion sensor, the photo sensor, and the light source.

In another exemplary embodiment, the control unit wakes up the sight from the sleep mode after the time that the control unit receives the detection signal.

The invention also provides an operating method of a sight. The operating method in accordance with an exemplary embodiment of the invention includes controlling brightness of a light source; having the sight entering a sleeping mode; detecting motion of the sight through a motion sensor; and waking up the sight when a change of a motion direction of the sight is detected.

In another exemplary embodiment, the operating method further includes memorizing a brightness mode executed before the sight enters the sleep mode, and executing the brightness mode when the sight is woken up.

In yet another exemplary embodiment, the brightness mode includes a high brightness mode, an intermediate brightness mode and an auto ambient detection mode.

In another exemplary embodiment, the sight enters the sleep mode when a power source provides power for the sight for a predetermined period.

In yet another exemplary embodiment, the sight is waked up after the time that the change of the motion direction of the sight is detected.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flow chart of an operating method of a conventional sight;

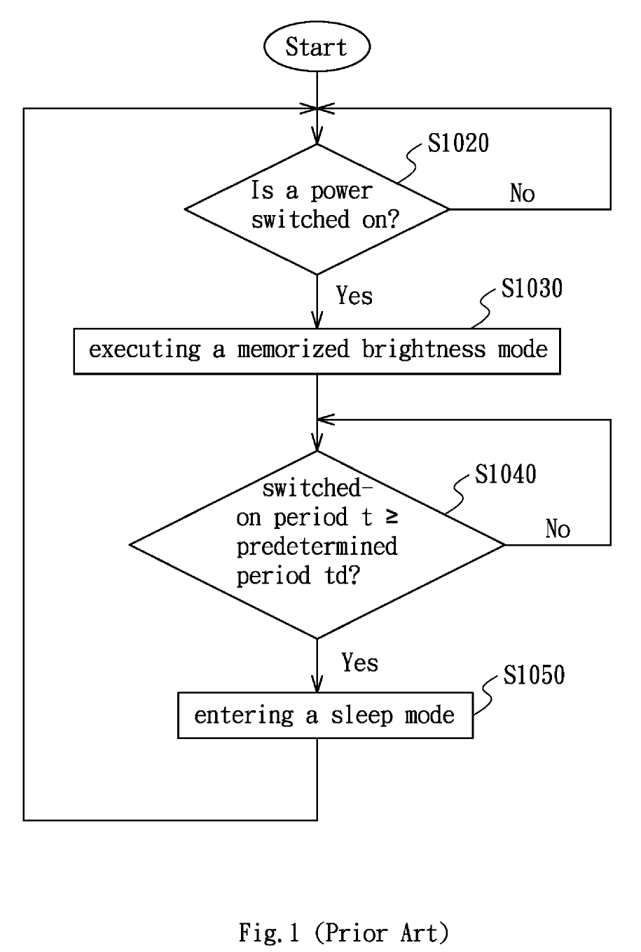

FIG. 2 is a flow chart of an operating method of a sight of the invention; and

FIG. 3 is a block diagram of a sight of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

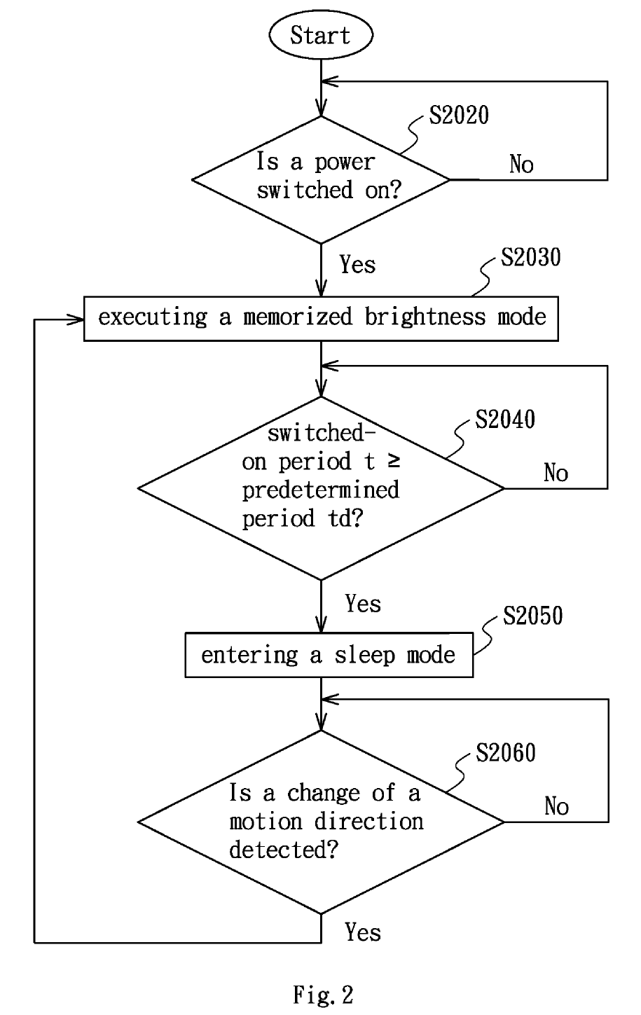

Referring to FIG. 2, an operating method of a sight of the invention is described as below.

In step S2020, it is determined whether a power switch is on. When the power switch is switched on, it indicates that a user is going to use the sight and the procedure goes to step S2030.

In step S2030, a memorized brightness mode is executed. The memorized brightness modes may be, for example, a high brightness mode, an intermediate brightness mode, or an auto ambient detection mode.

In step S2040, it is determined whether the sight needs to enter a sleep mode for saving power. If the power source has been switched on for a period t equaling or exceeding a predetermined period td, then step S2050 is executed to enter the sleep mode for saving power. On the contrary, if the power source has been switched on for a period t less than the predetermined period td, then the sight keeps normally operating.

In step S2050, the sight enters the sleep mode for saving power.

In step S2060, a motion sensor is used to determine whether a user is about to use the sight. When the user moves a weapon equipped with the sight of the invention, the sight moves along with the weapon. Then, a change of a motion direction of the sight is detected by the motion sensor, and the procedure returns to the step S2030 in which the memorized brightness mode is executed. That is, the sight is woken up and returns to the brightness mode executed before the sight enters the sleep mode, whereby the user does not need to switch on the power source again to wake up the sight. Therefore, the sight is able to provide more time for the user to aim at an object. On the contrary, if no motion of the sight is detected, the procedure returns to the step S2050 to maintain the sight in the sleep mode.

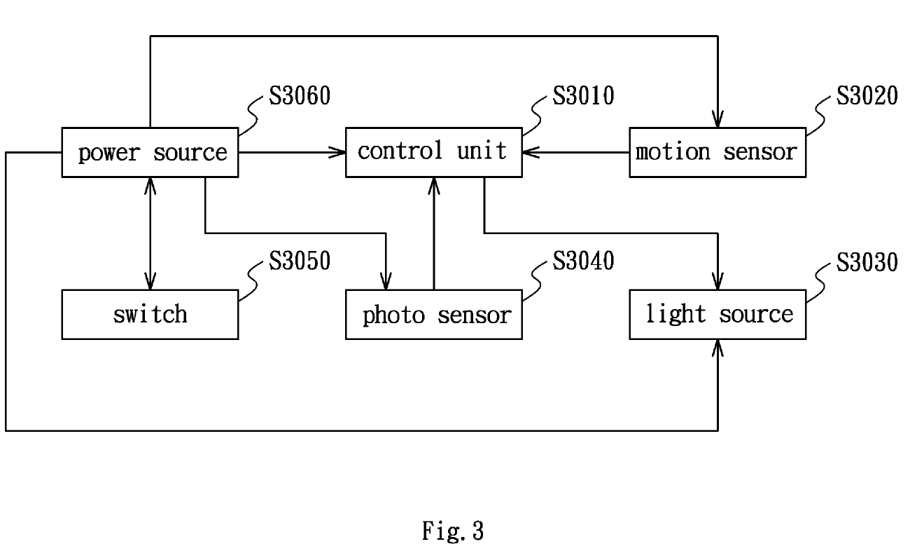

Referring to FIG. 3, the sight of the invention includes a control unit 3010, a motion sensor 3020, a light source 3030, a photo sensor 3040, a switch 3050 and a power source 3060. The switch 3050 is used to turn on or turn off the power source 3060. The power source 3060 is used to provide power for the control unit 3010, the motion sensor 3020, the light source 3030 and the photo sensor 3040. The control unit 3010 is configured to receive detection signals from the motion sensor 3020 and the photo sensor 3040 for succeeding operations and control brightness of the light source 3030 according to the selection of the brightness modes. In detail, the control unit 3010 controls the brightness of the light source 3030 according to the selected brightness mode. In the high brightness mode, the light source 3030 is regulated to generate highest brightness. In the intermediate brightness mode, the light source 3030 is regulated to generate intermediate brightness. The photo sensor 3040 is configured to detect ambient brightness and provides ambient brightness information for the control unit 3010. In the auto ambient detection mode, the control unit 3010 controls the light source 3030 to generate high brightness so that the aiming mark is visually clear in day time or in sufficient light, and to generate intermediate brightness in dim light for saving power but the aiming mark is still visually clear. The motion sensor 3020 is configured to detect the motion of the sight. When a change of a motion direction of the sight is detected, the detection signal is transmitted to the control unit 3010 to wake up the sight.

What is claimed is:

1. A sight, comprising:
a light source;
a motion sensor configured to detect a change of a motion direction of the sight and generate a detection signal based on the change of the motion direction; and
a control unit configured to control brightness of the light source and determine whether the sight enters a sleep mode, wherein the control unit wakes up the sight from the sleep mode when the control unit receives the detection signal.

2. The sight as claimed in claim 1 further comprising a photo sensor configured to detect ambient brightness and provide ambient brightness information for the control unit, wherein the control unit controls the brightness of the light source according to the ambient brightness information.

3. The sight as claimed in claim 2 further comprising a power source configured to provide power for the control unit, the motion sensor, the photo sensor, and the light source.

4. The sight as claimed in claim 1, wherein the control unit wakes up the sight from the sleep mode after the time that the control unit receives the detection signal.

5. An operating method of a sight comprising:
controlling brightness of a light source;
having the sight entering a sleeping mode;
detecting motion of the sight through a motion sensor; and
waking up the sight when a change of a motion direction of the sight is detected.

6. The operating method as claimed in claim 5 further comprising:
memorizing a brightness mode executed before the sight enters the sleep mode; and
executing the brightness mode after the sight is woken up.

7. The operating method as claimed in claim 6, wherein the brightness mode comprises a high brightness mode, an intermediate brightness mode and an auto ambient detection mode.

8. The operating method as claimed in claim 6, wherein the sight enters the sleep mode when a power source provides power for the sight for a predetermined period.

9. The operating method as claimed in claim 5, wherein the sight is waked up after the time that the change of the motion direction of the sight is detected.
